(19) United States
(12) Patent Application Publication
(10) Pub. No.: US 2009/0153811 A1
(43) Pub. Date: Jun. 18, 2009

(54) Cooperative Pointillistic Projection of a Graphical Image on a Pre-Selected Remote Surface by Using a Multiplicity of Lasers

(76) Inventors: Mark Stephen Braiman, Cazenovia, NY (US); Dusten Joseph Blake, Cazenovia, NY (US)

Correspondence Address: Mark S. Braiman, 4775 East Lake Road, Cazenovia, NY, 13035-9347, US

(21) Appl. No.: 12/269,039

(22) Filed: Nov. 12, 2008

Related U.S. Application Data
(60) Provisional application No. 60/987,087, filed on Nov. 11, 2007.

(51) Int. Cl. G03B 21/14

(52) U.S. Cl. 353/121; 353/30; 353/28

(57) ABSTRACT

A method is described for multiple persons operating lasers to cooperatively project a pointillistic graphical image onto a remote surface. The visibility of the projected image depends on aiming the lasers with accurate relative displacements. Invariant features of the specific remote landscape where the image is to be projected are used as guideposts for maintaining these displacements. A set of transparent images is distributed to the laser operators, designating for each a spot to illuminate, superimposed on a scaled representation of the background landscape. In the preferred embodiment, each transparent image is used as a reticle, mounted into a monocular at its internal focal plane with the designated illumination spot centered on-axis. A laser is also rigidly attached to the monocular, with their optical axes parallel. Each operator aims his/her laser by visually sighting through the monocular so as to align transparent and direct views of the target landscape.

### CROSS-REFERENCE TO RELATED APPLICATION

This application claims the benefit of provisional application U.S. 60/987,087 filed Nov. 11, 2007 by Mark S. Braiman.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The field of the invention is mass communications and public relations.

Existing methods for projecting complex graphical images on remote surfaces (>100 m from the light source) generally depend on positional modulators that rapidly alter the direction of a single powerful laser beam. This permits an entire image to be drawn in either raster-scan or vector-graphic mode, within the roughly 30-millisecond response time of the human visual system.

Complex vector-graphic laser images generated from a small number of high-powered lasers are now routinely projected over distances of approximately 1 km, e.g. during commercial light shows such as are presented at Stone Mountain near Atlanta Ga. and at the Grand Coulee Dam.

Furthermore, methods for combining the output of multiple lasers of different colors into a single beam, which can then be passed through a single set of time-modulated optics for full-color projection, are described in U.S. Pat. No. 6,154,259 “Multi-beam laser scanning display system with speckle elimination.” Methods for accomplishing raster-scanning of laser images that are composed of 3 different-colored lasers to produce full-color laser images on remote projection screens, e.g. in movie theaters and outdoor venues, have been described in U.S. Pat. No. 7,102,700.

Scaling up the projection distance more than about 10-fold, i.e. to >10 km, with existing methods is limited ultimately by problems of heat dissipation from the laser source and from directional reflectors. In order for an image projected onto a white surface to appear brightly visible to the unaided eye, its features should typically be illuminated with an illuminance contrast, relative to the background, of approximately 200 lux (lumen per square meter), or approximately 1 W/m² for 630-nm light. (This is the typical requirement to produce an easily visible image with clear color. The lower limits of visual detectability against a dark background are at least 1000-fold less).

A fairly simple red graphical image on a dark background surface 1 km from a laser light source might require illumination of a total area of 1 m². In this case, 1 W of total laser power would suffice to produce a visible image. However, projecting an image of the same angular extent and brightness onto a surface 20-fold more remote, i.e. 20 km away from the source, would require illumination of an area of 400 m². In this case, at least 400 Watts of laser power at the same wavelength would be required to maintain the same visibility of the image, even disregarding intensity losses from light scattering.

Visible laser sources of such great power as 400 W are quite expensive and rare, largely due to their requirements for >1 kW heat dissipation from the lasing medium, which typically can convert only well under half of the input energy into output light. Thermal damage to the surfaces of directionally-modulated mirrors also becomes a problem at such intensities. Such high-power lasers also present serious risks for ophthalmic and bodily injury due to their high intensity, and therefore are generally available for use in very limited circumstances, under the control of centralized government authorities. A less centrally-regulated means of producing images that are easily visible to large numbers of observers would likely be an attractive proposition to many types of organizations and groups of people interested in mass communications.

An alternative strategy for projecting laser images, other than using a small number of high-power lasers, was described in U.S. Pat. No. 5,818,546—“Apparatus for imaging exit spots of a laser array”. In this method, an array of laser point sources are each individually imaged onto different points on a remote surface. The overall image is thus created pointillistically. With this method, the shape of the remote graphical image is programmed by starting with a known distribution of the array of lasers, and then fixing their relative directions via optical modulators. This method thus depends on knowing the exact relative positions of each of the individual lasers in the array. The entire laser array must therefore in a sense be under the direct control of a single manufacturer.

An alternative type of laser array with suitable power to project visible images upon a remote surface is conceivable with current technology and economics. The low cost of hand-held laser pointers has brought them within easy reach of most households in the industrial world. There are a number of cities within the US where such laser pointers likely already have an aggregate light power of well over 400 W. In a city of 10 million people, for example, this would require that only 4% of the population own a 1-mW laser pointer, a market penetration that has likely been reached in a good number of cities in the USA as well as other industrialized nations. The aim of the current invention is to find a way to harness such a population of individual laser owners, as a laser array, without requiring their positions to be known relative to each other as in U.S. Pat. No. 5,818,546.

It has previously been proposed to use multiple inexpensive handheld laser pointers to illuminate a remote surface, but without any practical means of pointing them in coordination. The ultimate remote surface upon which people have envisioned using laser pointers to create a graphical image is the Moon. For example, the artist James T. Downer proposed in the year 2001 to direct thousands or millions of laser pointers to create a single red spot on the Moon, visible from the Earth's surface. However, this proposal was shown to have serious technical problems, due in part to the large surface area of the Moon over which the intensity from the pointers would be directed if they were used without additional optics. (http://www.xent.com/pipermail/fork/2001-August/002851.html). This would have resulted in a requirement for a number of laser pointers, in order to make the spot sufficiently strong to be visible, that would exceed the population of the Earth by factors of many thousands. In this and other published critiques of the proposal, it was recognized that improving the collimation of the laser pointers to around 0.25 milliradians could in theory reduce the surface area that they would illuminate on the Moon to a level that would permit the illumination to succeed with only billions of lasers.

However, the technical problem of aiming billions of handheld lasers at a specific point on the Moon simultaneously, with an accuracy of <0.25 milliradians, has seemed to be unsurmountable at any reasonable cost. No practical solution to this particular technical problem was ever successfully developed.

It is this general technical problem that is solved by the instant invention. The particular solution proposed is non-obvious—otherwise it would likely have been proposed by James Downer, or at least have been considered by one of the many technical critics of his proposal.

It relies on the choice of a remote target surface for illumination that is non-uniform, i.e. that has specific features that are easily recognized by humans. In this regard, the method is completely different from all earlier methods for laser projection, which create an image using angular displacements that are generated purely at the location of the laser, without reference to any features of the remote target surface. These older methods work equally well regardless of the surface upon which the image is to be projected, and in fact work best upon a featureless projection surface. The new method described herein, by contrast, would not work at all for projecting upon to a featureless surface. It is absolutely dependent on the presence of recognizable features in the remote surface, to serve as guideposts for pointing the lasers correctly.

This invention comprises methods for projecting the aggregate power of multiple weak lasers onto a pre-defined remote surface in a coordinated fashion, in order to create images that are supported or endorsed by a large number of participants, making it possible to enlist their cooperation. Such images could include, for example, political messages as well as expressions of enthusiasm for universities, sports teams, musical groups, or cultural events hosted by a city. One advantage of this mass-participation approach is that it can eventually permit a degree of democratization of the “push” aspect of a mass medium. Using this approach, a critical mass of people could elect to communicate a message that would then be made visible to the naked eye—in fact, nearly inescapable—for a hundred-fold greater number of passers-by.

Such an opportunity is likely to be very appealing to a number of potential users of the invention. Several examples of the invention's utility, giving specific locales matched with specific messages projected onto specific remote surfaces, are given below.

### Example #1

Projecting an image of Canada's maple-leaf logo from Vancouver onto Cypress Mountain during the 2010 Winter Olympics. The top of Cypress Mountain is about 20 km distant from downtown Vancouver, and is visible from much of the city, whose resident population is nearly 600,000. This population will likely be significantly boosted for periods of time of the Olympics. Thus the idea of directing 200,000 red laser pointers from downtown Vancouver simultaneously onto the top of Cypress Mountain is a reasonable goal, under these specialized circumstances

A simplified image of the Canadian maple-leaf symbol, drawn with just 39 overlapping spot-pixels, is shown in FIG. 1 superimposed upon the view of Cypress Mountain from downtown Vancouver.

The maple-leaf symbol extends vertically over approximately ⅙ of the 1200-meter height of the peak (measured from the sea level in the foreground of the picture), or about 200 meters. This corresponds to 1% of the 20-km distance from Vancouver, so the entire maple-leaf image would occupy nearly 10 milliradians of view. Each spot is about one-tenth of the height of this image, corresponding to a 1-milliradian size—about that for a typical laser pointer. With five thousand 5-mW lasers (25 W total) assigned to each of these thirty-nine 1-milliradian spot-pixels, or a total of about 200,000 laser pointers, it should be possible, on a clear winter evening, to attain an image brightness for each spot-pixel corresponding to that of a single laser at a distance of 150 m. “Official” sponsors might wish to boost the laser intensity with more powerful lasers of their own. However, not only the Canadian hosts of the Olympics, but visitors as well, might be strongly motivated to participate in a festive celebration of cooperative action by hundreds of thousands of people.

### Example #2

Projecting a golden-yellow image of the letter “C”, a symbol for the University of California, onto the Berkeley Hills from downtown San Francisco and southern Marin County. Once again, the remote target location is about 20 km away from the laser projectors. With tens of thousands of alumni of the University of California living and/or working in San Francisco (total population nearly 800,000), it should be possible to project an image of a “C” that would dwarf the existing 60-foot concrete “Big C” embedded in the side of Charter Hill, above the Berkeley campus. The yellow-painted surface area of the latter is approximately 30 m².

Magnifying the size of the existing painted “Big C” by just over 3-fold with light, to create a bright 60-meter-high “C”, as in FIG. 2, would require illuminating approximately 300 m² of the hillside with roughly 300 W of laser power. This should be attainable by using about 150,000 laser pointers, each with an average of 2 mW of power. In this case, it would be desirable to use a mix of green and red pointers. An all-red “C” would certainly not be acceptable to the alumni of the University of California, since that is the color of its principal rival (Stanford).

It is well known that the human visual system perceives as yellow a wide range of possible mixtures of red (>600 nm) and green (˜530-550 nm) wavelengths. Roughly equal numbers of both red and green lasers would suffice to give the illuminated area a nice golden yellow appearance. The exact color appearance could be controlled most accurately if a large fraction of the human projectors had at their disposal both red and green laser pointers, and could switch between them depending on the perceived need.

### Example #3

Projecting a political slogan onto the Soldiers and Sailors Monument in Clinton Square in Syracuse N.Y., as shown in FIG. 3. This monument, like many others, has approximately 4-fold rotational symmetry, so that a single planned image would be suitable for projecting the same political slogan onto all 4 faces of the monument.

Political or religious slogans suitable for projection onto monuments or buildings could include not only pleas for government action (“Equal Rights Now”) or prayers (“Save the Planet”, “Respect Unborn Life”), but also expressions of voter support for individual candidates (“Honest Abe for Senator”, “Re-Elect The President”).

### BRIEF SUMMARY OF THE INVENTION

A method is described for projecting a graphical image accurately onto a remote surface using multiple inexpensive laser pointers. Each laser illuminates a single spot within the overall pointillistic image. The shape and brightness of the pointillistic image depends on large numbers of human operators aiming these lasers with accurate relative displacements. A simple method for a group of many ordinary persons, without special technical skills, to maintain these displacements accurately is described. This method makes directional guideposts out of invariant visual features of the specific remote landscape that includes the surface where the image is to be projected. The most important step in this method is the distribution of a set of planned transparent images, designating for each laser's operator the point within the projected image that he/she should illuminate, superimposed on a correctly-scaled representation of the background landscape showing easily-recognized visual features. Each transparent image must be mounted into a sighting optical device, either by technician(s) responsible for distributing the sighting optical devices or by the operators themselves, in such a way as to align the operator's close-up view of the transparent image of the target landscape with his/her more distant direct view of the same landscape. In the preferred embodiment of the invention, the sighting optic is simply a monocular or viewing scope, and the transparent image must be mounted to coincide at an internal focal plane within the monocular. Each operator's point of illumination, designated as the central point of his/her specific transparent image, must be positioned precisely at the monocular's internal on-axis focal point, i.e. where a reticle cross-hair might typically be found. Each sighting optic must also have a laser rigidly mounted to it, so as to make the optical axes of the laser and the sighting optic parallel, while giving these axes a lateral separation that is small compared to the spot size of the laser upon the remote target. If these conditions are met, then each operator's laser will be properly directed upon the correct assigned spot on the remote target surface, even if the laser beam is individually too dim to be seen at such a great distance. The composite image of the laser beams from all the operators will produce the planned image if the total power of the lasers is sufficiently large.

### BRIEF DESCRIPTION OF THE SEVERAL VIEWS OF THE DRAWING

FIG. 1 is an example of a “planned image”, as referred to in the detailed description. This planned image consists of a photographic image of Cypress Mountain as viewed from downtown Vancouver, British Columbia, along with a digitally-superimposed graphic representing the Canadian maple-leaf symbol. The maple-leaf graphic is composed of just 39 pixels, drawn as overlapping circular spots.

FIG. 2 is a second example of a planned image, consisting of a photographic image of the Berkeley Hills in the East Bay region and portions of San Francisco Bay, as viewed from the west (i.e. from the direction of downtown San Franscisco); along with a digitally-superimposed graphic representing the letter “C”, a symbol for the University of California.

FIG. 3 is a third example of a planned image, consisting of a photographic image of the Soldiers and Sailors Monument in Clinton Square, Syracuse N.Y., as viewed from the west; along with a digitally-superimposed graphic of the phrase “Troops Home Now”.

FIG. 4 is a simpler example of a “planned image”, as referred to in the description of the invention, consisting of a photographic image of the Carrier Dome in Syracuse N.Y., as viewed from Lincoln Park to the north; along with a digitally-superimposed graphic consisting of two individual spot-pixels indicated by rectangles of different shading.

### DETAILED DESCRIPTION OF THE INVENTION

What follows is a description of the preferred embodiment of the invention, which is a method for projecting a planned graphical image upon a remote target surface with multiple laser beams controlled by multiple persons known as laser projectors, each laser beam contributing only one compact point or patch of light to the graphical image. This method requires that a number of simple sequential steps be carried out with precision by a planning person or committee, and then additional simpler steps carried out in a coordinated fashion by a large number of laser projectors.

(1) First, a “planned image” must be created, consisting of a photograph, drawing, or other scale likeness of a landscape or cityscape that includes the remote surface upon which the image is to be projected, called the “target surface”. The target surface could consist of a human-fabricated object, such as a monument, a large wall, or a wall or ceiling or domed roof of a building. It could even consist of the surface of the waters of a fountain. Alternatively, it could consist of a natural geologic formation, such as the side of a mountain, butte, or waterfall, or even the bottom or sides of a canyon as viewed from high above. The most important characteristic of the target surface, however, is that it should present easily-recognized visual features that lack translational symmetry, i.e. the target surface superimposes upon itself in a unique horizontal and vertical position. The planned image should show the expected view of the target surface from the position of a typical member of the group of laser projectors. It should also show the desired graphical image superimposed upon the image of the target surface.

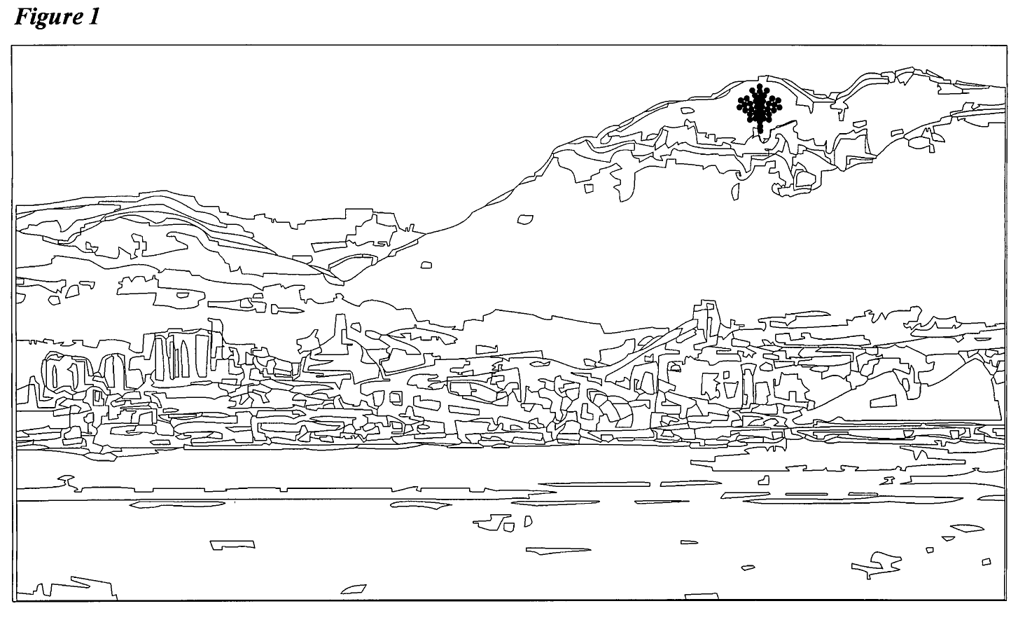

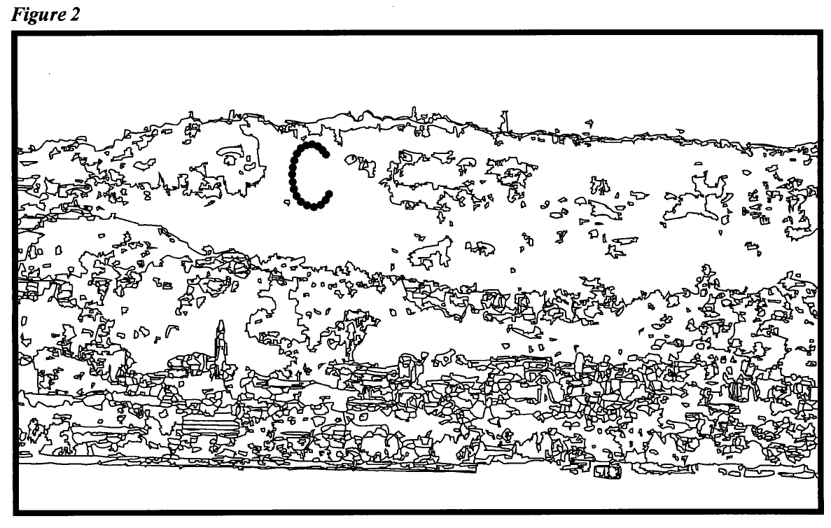

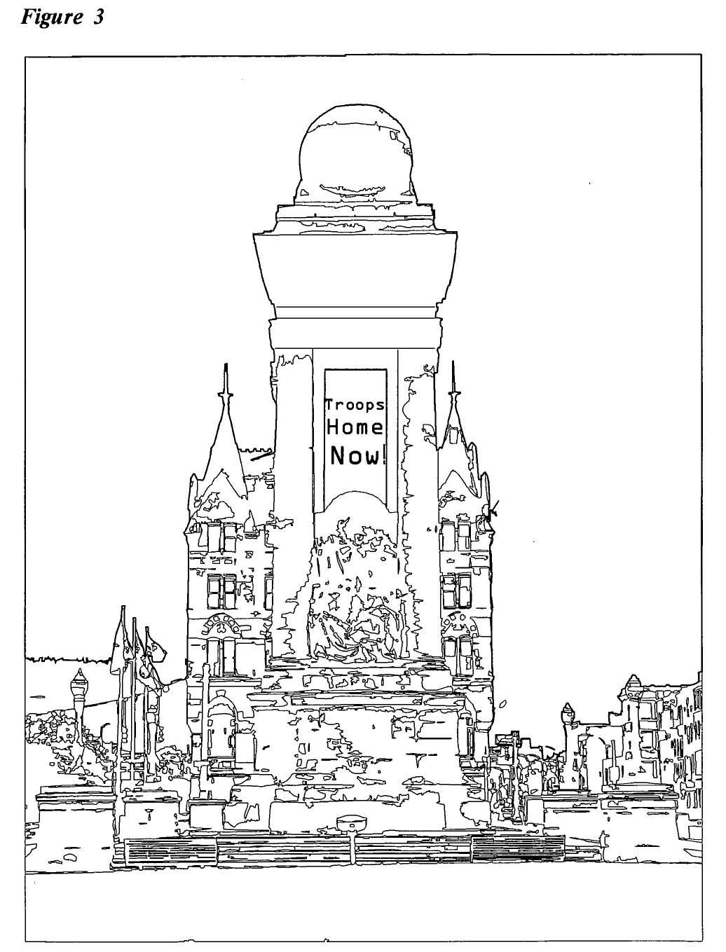

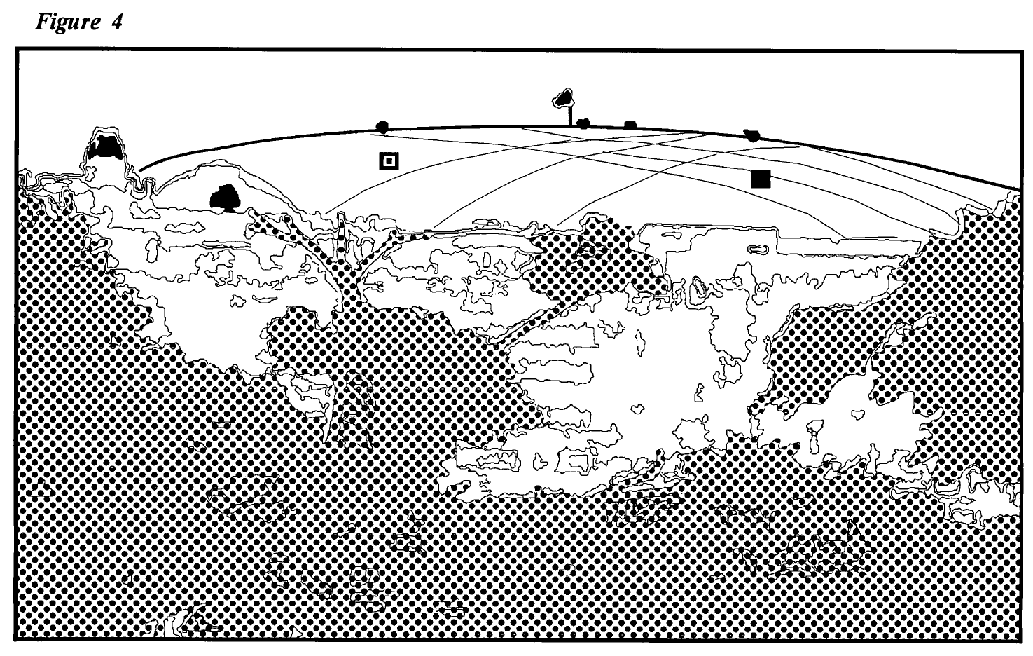

A number of examples of planned images are shown in FIGS. 1-3. A simpler example of a planned image is shown in FIG. 4. It consists simply of two spots projected upon the white fabric domed roof of the Carrier Dome at Syracuse University. In this case, the target surface is the domed fabric roof. The two spots are indicated with different shades of gray to indicate that they are envisioned as having different colors. This image, shown at right, is based on a simple digital photograph taken by the inventors from Syracuse's Lincoln Park, some 1.5 miles to the north of the Carrier Dome. The two spots, each with an angular extent of about 1 milliradian as viewed from Lincoln Park, constitute a very simple graphical image to be projected upon the Dome. They were added to the initial photographic image with Corel PhotoPaint.

The planned image does not have to contain all the rich detail of a photograph as shown here in the preferred embodiment. Rather, it need include only a sufficient number of well-contrasted edge features for the human visual system to be able to define the positions of the spots contributing to the graphical image, to within the desired angular resolution of that graphical image, and also for each laser pointer to align the planned image against the actual viewed scene, once again to within the same desired angular resolution. For example, it is clear that a high-contrast graphic that highlights the edges, or even a scale line drawing of the Carrier Dome and a few surrounding features of the landscape, e.g. the Hall of Languages to its left, would suffice to define the location of the two-spot-pixel graphical image upon the Dome roof accurately to within the 1-milliradian size of the spots. In this case, and in most other cases, the sizes of spots that can be used to compose the planned image will correspond to the desired angular resolution.

(2) Next, it is necessary to make multiple transparent image copies of the planned image, each with a designating mark or marks specifying a particular spot-pixel within the desired graphical image. Sufficient numbers of different spot-pixel designations among the transparent copies must be made, so as to permit the overall graphical image to be created from the aligned composition of all the designated spot-pixels. In the case of the image shown above, just two different types of transparent image copies are needed to create the desired graphical image, each designating just one of the spot-pixels that constitute the image. For a graphical image consisting of 39 spot-pixels (as in example #1 above), 39 different transparent image copies would be required so that the aligned image copies create the desired graphic.

There are a number of ways of providing a designating mark for each of these spot-pixels. One simple way is to draw cross-hairs through the specified spot-pixel. A second is to draw multiple arrows or other pointers aimed at the same unique spot-pixel. A third alternative is to draw one or more circles centered about the specified spot-pixel. A fourth is to crop the planned image in such a way that the specified spot-pixel is at its precise center. Any of these techniques works equally well for widely-separated spot-pixels. For closely-spaced spot-pixels, cross-hairs are helpful for getting the most accurate positioning.

Additionally, for the preferred embodiment of the invention, which utilizes a type of sighting optic (see below) consisting of a monocular that has an eyepiece lens mounted in a cylindrical tube, circularly cropping the planned image to fit tightly within the eyepiece tube at the focal plane of the eyepiece, along with providing partial crosshairs (i.e. missing a small region of the crosshairs near where they would intersect at the designated spot-pixel), is the preferred embodiment of a “designating mark.”

In order to produce the transparent image copies, it is sufficient to provide a digital file (a .tiff or .jpg file, for example, but other standardized formats are possible) of each image with a different set of cross-hairs or other designating marks superimposed, to a digital photography house that can transfer the electronic images onto transparency film. The correct magnification of the images must be chosen, so that when each transparency is viewed in a pointing device (a “sighting optic”, which may or may not have a magnifying optical system), the apparent size of the target surface in the transparency will approximately match the apparent size of the actual target surface from the point of view of the laser projectors. Producing transparencies with a variety of magnifications may be helpful, as well as the provision of a table designating the combinations of magnifying power and distances that are suitable for use with each transparent image copy. That is, a single transparent image size might be simultaneously suitable for use in a sighting optic with a 100-mm objective focal length at 1 km; as well as a sighting optic with 200-mm objective focal length at 2 km; 300 mm at 3 km; etc.).

For a sighting optic with a magnifying optical system, the expected position of mounting of the transparent image is at the location of the internal focal point, where a real image of the remote target surface is formed. The laser will be pointed by aiming the sighting optic so as to make the real image of the target surface and its duplicate in the transparent image copy coincide at the focal plane of the optical system. In this case, the proper reduction in size of the transparent image copy, relative to the target surface, can be calculated by a simple formula. Let us call this size reduction factor r. That is, the size of a particular feature upon the actual target surface is r times as large as its size in the transparent image located at the focal point of the optical system. Then the proper value of r then is equal to a simple ratio: the expected distance d of the laser projector from the target surface, divided by the focal length f of the objective lens in the imaging system. That is, r=d/f.

As an example, for a simple monocular that has a objective focal length of f=100 mm, and a distance to the target surface of d=20 km, the proper value of r is (20,000 m/0.1 m=200,000). Thus, a feature visible in the transparent image copy with an extent of 1 cm should correspond to a feature in the real target surface that is 200,000 cm, or 2 km in extent. The transparent image should be a 1/200,000× reduction in size of the actual target surface. Note that the proper image size reduction does not directly depend on the focal length f□ of the ocular eyepiece, although the value of the objective focal length f in the formula above can be generally substituted by Mf□, where M is the magnification of the optical system.

For a sighting optic that has no magnifying optical system, a similar formula r=d/f can be used, except that the value of the objective focal length (f) must be substituted by the distance of the transparent image copy from the user's eye. That is, the same 1/200,000× reduction that is suitable for use with a magnifying system having a 100 mm objective focal length can be used in a non-magnifying system at the same 20 km distance from the target surface, as long as the transparent image copy is held 100 mm away from the user's eye.

(3) The next step is to distribute one of the transparent image copies to each of a group of laser projectors who, at the chosen time of projection of the image, are to be positioned in somewhat of a cluster. For the laser projectors to be in a useful cluster, they should all have viewing angles of the target surface that differ from that of the planned image by as little as possible, but certainly no more than 30 degrees of parallax angle. At larger angles, the aspect ratio of the target surface in the transparent image will likely differ too much from that in the actual view of the target surface, and this will cause confusion that will make it impossible to properly align the image. In addition, it is helpful if the laser projectors are also at roughly similar distances from the target surface, so that the apparent magnification of the transparencies can be the same, and they can therefore all use the same type of “sighting optic” as described below.

(4) It is necessary to provide the group of laser projectors with the time or set of times for the coordinated projection of their lasers.

(5) It is also necessary to make sure that each individual laser projector is familiar with the general method for using the transparent image copy in order to point his/her laser properly at the designated spot-pixel, even if the remote surface is too distant for the spot that individual laser to be visible to the laser projector. A general set of instructions for doing this alignment is as follows. (More specific sets of instructions that pertain to particular types of sighting optics are provided in the subsequent section):

(a) The first step each laser projector must take is to obtain a sighting optic, which is defined by this paragraph, as follows. The sighting optic must have two input optical axes and one or two output optical axes. These optical axes and the sighting optic should also meet the following conditions. First, the sighting optic must include the means to mount and align a laser stably along one of the input optical axes (the “laser optical axis”). Second, the projector's eye must be able to sight into and along the other input optical axis (the “sighting optical axis”). Additionally, if there are two distinct output optical axes, then one must be optically coupled with each of the input axes; the two output optical axes, then also corresponding to the “laser optical axis” and the “sighting optical axis”, must furthermore be parallel. If there is only a single output optical axis, then this “combined output optical axis” must be coupled in alignment with both input optical axes by means of a beamsplitter. Additionally, whatever type of sighting optic is used, it must come equipped with the means to affix the transparent image copy perpendicular to the sighting optical axis, with its lateral position adjusted so that the designated spot-pixel is aligned precisely upon that sighting optical axis. Finally, an accurate definition of the sighting optical axis may also require that the sighting optic contain a rigidly-mounted aiming reticle or crosshair, which will designate a particular point along the “sighting optical axis” of the sighting optic.

By the definition above, the sighting optic can thus be any one a number of fairly well-known optical devices. (These are preferred embodiments of a sighting optic, but other embodiments are possible that meet the definition above). (i) a telescope with a sighting scope; (ii) a telescope with a dichroic beamsplitter and dual oculars, one of which contains an aiming reticle; (iii) a pair of binoculars with one of the eyepieces equipped with an aiming reticle; or, in the preferred embodiment, (iv) a monocular that includes a prism inverter so that the viewed image is upright. The specific preferred embodiment is a 10×25 mm monocular, such as a Tasco monocular model 568 BCRD (UPC code 46162 00569).

In most of these examples of a sighting optic, including the preferred embodiment, the sighting optic includes a magnifying system for the viewer, but this is not absolutely necessary, and a very large magnification factor (above about 12×) will make it more difficult for a typical untrained user to properly aim the laser. In any case, however, the sighting optic must either come equipped with a laser stably aligned and affixed to it, or else include some mechanical means for an average person to stably align and affix such a laser to the sighting optic as described in the next step below. Device (iv), a simple monocular, is the preferred embodiment for producing a low-resolution pointillistic image, with individual spot-pixels of >0.25 milliradian in angular extent. Device (i), a telescope with a parallel sighting scope, is the preferred embodiment for producing a high-resolution pointillistic image, with individual spot-pixels of under 0.25 milliradian in extent. However, these are not the only possible embodiments of sighting optics that are suitable for use with this invention. In particular, a sighting optic with better-than-needed resolution can always be used to help produce an adequate low-resolution image, when used in combination with lower-resolution sighting optics.

(b) The next step is for each projector to follow is to affix a laser rigidly to each sighting optic, if the sighting optic did not come pre-equipped with a mounted laser. In particular, if the sighting optic has a laser expanding/collimating optical system (i.e. a telescope operated in reverse), then when the projector affixes the laser, the laser beam must be aligned coaxially with this expander/collimator, so as to permit undistorted magnification. In any case, the laser must be affixed rigidly and firmly, so that its angle with respect to the sighting optic does not vary significantly under expected mechanical stress such as shaking or knocking. What constitutes an appropriate level of precision and accuracy of the laser alignment with respect to the expanding/collimating system depends on the desired angular resolution of the final image. If the spot-pixels in the target image must be of 1 milliradian size or less for the image to be meaningful, then the alignment accuracy of the lasers should typically be well within 1 milliradian, and in the preferred embodiment would be under 0.5 milliradian.

(c) The next step is to mount the transparent image perpendicular to the “sighting optical axis” of the sighting optic, with the designated spot-pixel centered precisely upon the sighting optical axis. This step is only necessary if the sighting optic did not come pre-equipped with a mounted transparent image in the proper position. For a sighting optic (i) that consists of a telescope with a sighting scope, the viewing optical axis is the optical axis of the sighting scope. For a sighting optic (iii) that consists of a pair of binoculars, the viewing optical axis is the optical axis of the ocular that the laser was not affixed upon in step (b). For a sighting optic (iv) that is a monocular, the sighting optical axis is the optical axis of the eyepiece lens system.

(d) The next step is to perform a final “close-in” alignment of the sighting and laser optical axes to make them parallel. The laser beam is turned on while the sighting optic is pointed at a simulated target surface which is at a distance of 30-300 meters away from the projector, i.e. sufficiently close to be able to see clearly the output laser spot. When viewed through the transparent image copy along the sighting optical axis, this laser spot should be centered precisely upon the designated spot pixel, or displaced by a small distance corresponding roughly to the small separation of the laser optical axis and the sighting optical axis. The separation of these axes will typically be less than 30 cm, so that at the simulated target 30 m away, the laser spot will appear less than 10 milliradians displaced from the designated spot-pixel.

(e) The final step is for each laser projector to look into his/her sighting optic and to aim it, so that the transparent image within it is brought into the closest possible superposition with the projector's view of the actual target surface. This will have the effect of pointing the laser precisely at the designated spot-pixel, even if the light from the laser cannot actually be visualized upon the remote target surface.

The projector may opt to mount the entire apparatus rigidly upon a tripod or other stand, so that after alignment the laser can continue to project its light even without the projector's continuous presence.

Steps a-e will different significantly amongst different types of sighting optics, so a separate instruction should be provided to the users of each particular type. Examples of such specific instructions are provided in greater detail below for 4 types of sighting optics.

Examples of particular types of sighting optics to be used in conjunction with the methods described above.

(i) Telescope with sighting scope. A particular embodiment of this type of sighting optic is an American standard telescope. A specific model that has been adapted and tested is a Tasco Luminova telescope (Tasco model 40-114675). This is a Newtonian reflector telescope with a 900 mm focal length. When equipped with one of the standard eyepieces that was shipped with it, having a 20-mm focal length, the telescope's magnification is 900/20=45×, which is sufficient to collimate a laser pointer beam from 1 milliradian divergence down to <0.03 milliradian. A cylindrically-symmetric adapter was fabricated by a local machine shop to make a press-fit with both the eyepiece and with a simple laser pointer having a ⅝″ external diameter. This resulted in the laser beam being expanded 45×, and its observed diameter at the exit of the telescope was indeed about 45 mm, or nearly half of the 114 mm aperture.

This telescope came equipped with a 5× Keplerian sighting scope on a parallel mount. The sighting scope has an objective focal length of 100 mm, and the scope's optical axis is offset from the main telescope optical axis by approximately 6 inches (15 cm). Suitable instructions for step “c” above are:

“It is simple to unscrew the eyepiece of the finder scope from the scope's body, and to attach a correctly-sized transparent image upon the pre-existing crosshairs with a few drops of a temporary cement (such as rubber cement). The center of the finder scope's crosshairs should be made to coincide with the spot-pixel designated in the transparent image”.

Suitable instructions for fine alignment of the sighting optic (step “d” above) in the preferred embodiment are: “After firmly coupling the laser to the eyepiece adapter, rotate the telescope in its mount as needed to position the finder scope directly above the center of the telescope barrel. Now point the telescope at a remote flat white surface, such as a projection screen. This distance to this surface should ideally approach the limits of visibility of the laser beam coming out of the end of the telescope. Adjust the focus of the telescope eyepiece and thereby the laser focus, until its beam is sharply focused on the remote surface. Fix the telescope so that it is stable and cannot be easily jostled out of position, and place a cable-tie or metal clamp ring around the laser “on” switch, so that it does not require constant pressure from your finger to remain on. Go to the remote surface, and make two temporary marks on this surface: one at the position of the laser beam, and another 15 cm directly above it. These marks should be sufficiently distinct to view with the finder scope, once you return to the telescope's position, but also small enough to correspond to an angular extent of under 0.1 milliradian. For example, if the distance to the remote screen is 100 meters, 10-mm-diameter marks (e.g. thumbtacks or colored pressure-sensitive adhesive dots) are the right size for this purpose. Now, keeping the laser beam centered on the lower mark, view through the finder scope while adjusting its centering screws. Reposition these screws as needed to center the crosshairs in the finder scope upon the upper crosshair. One the finder scope is positioned properly, symmetrically tighten the positioning screws to make the positioning of the finder scope firm. Now you should attempt to adjust the focus of the telescope to make the laser beam perfectly collimated, rather than focused. That is adjust the focus so that the laser beam's diameter on the remote screen is as close as possible to identical with its diameter upon exiting the telescope. This diameter should be the diameter of the beam coming directly from the laser pointer, multiplied by the magnifying power of the telescope as equipped with a particular ocular lens. For this 45× telescope, the beam diameter is approximately 50 mm, or about 2 inches. Once this focus is adjusted, the telescope can be re-directed at the desired target with confidence that the laser will hit the point at the crosshairs of the finder scope, or rather a point within 6 inches of that centered in the crosshair. It may be necessary to rotate the finder scope within its mount, in order to rotationally align the focused image of the target surface with the transparency of the same image mounted inside the finder scope.”

(ii) Telescope with dichroic beamsplitter and dual oculars. This embodiment of a sighting device was realized by making some simple modifications to the Tasco Luminova telescope described above. The simple ocular was replaced by a Meade model 644 flip-mirror optical system. However, in this system the flipper mirror was replaced by a dichroic beamsplitter, consisting of a 45-degree dichroic mirror (25 mm in diameter, Edmund Optics part number 47266) held in a 25-mm optic holder (ThorLabs FMP1). In order to use the FMP1 optic holder in the Meade model 644 flip-mirror system, the FMP1 optic holder was first modified by having a hole drilled and reamed through it. This permitted the optic holder to be fitted with an axle, consisting of two hardened steel dowel pins that were press-fit into opposite sides of the reamed hole. Thus the dichroic mirror, optic holder, and axle could together replace the small 1-inch square mirror, holder, and axle that had come as part of the Meade model 644 flip-mirror system. Other than the drilling and press-fitting of the dowels, which were done by a professional machinist, these adjustments were all simple enough to make in the inventors' home, using a set of fine metric Allen wrenches.

The replacement of the aluminized mirror with a dichroic mirror permits the simultaneous use of two oculars. One was the same 20-mm focal length ocular described for sighting device (i) above, again equipped with an adapter allowing the simultaneous press-fitting of the ocular and a laser pointer so as to mate the laser to the ocular. The other ocular was a Kellner focusing eyepiece (Edmund Optics catalog number 37918), which has a 21.5 mm focal length and comes equipped with a cross-hair reticle. The cross-hair reticle in this ocular is held in place with a standard threaded optical clamp ring.

Thus suitable instructions for step “c” above are: “Unscrew the clamp ring holding the crosshair reticle in the Kellner eyepiece. Replace the thin glass disk reticle with the transparent image, which should have the same diameter as the circular reticle, and re-tighten the threaded clamp ring so as to clamp the transparent image into fixed position”.

Suitable instructions for fine alignment of the sighting optic (step “d” above) in the preferred embodiment are: “After firmly coupling the laser to the eyepiece adapter, point the telescope at a remote flat white surface, such as a projection screen. This distance to this surface should ideally approach the limits of visibility of the laser beam coming out of the end of the telescope. Adjust the focus of the telescope eyepiece and thereby the laser focus, until its beam is sharply focused on the remote surface. Fix the telescope so that it is stable and cannot be easily jostled out of position, and place a cable-tie or metal clamp ring around the laser “on” switch, so that it does not require constant pressure from your finger to remain on. Now you should adjust the angle of the dichroic mirror in the Meade flipper-mirror system, and possibly the precise press-fit of the laser pointer into its adapter, so that when you look into the Kellner eyepiece, the image of the laser beam falls exactly upon the designated spot-pixel as viewed through the transparent image inside the Kellner eyepiece. Finally, you should re-adjust the focus of the telescope to make the laser beam perfectly collimated, rather than focused. That is, adjust the focus so that the laser beam's diameter on the remote screen is as close as possible to identical with its diameter upon exiting the telescope. This diameter should be the diameter of the beam coming directly from the laser pointer, multiplied by the magnifying power of the telescope as equipped with a particular ocular lens. For this 45× telescope, the beam diameter is approximately 50 mm, or about 2 inches. Once this focus is adjusted, the telescope can be re-directed at the desired target with confidence that the laser will hit the point at the crosshairs of the finder scope, or rather a point within 6 inches of that centered in the crosshair. It may be necessary to rotate the Kellner eyepiece within its socket in order to rotationally align the focused image of the target surface with the transparency of the same image mounted inside the Kellner eyepiece.”

(iii) Monocular. This, the preferred embodiment of a sighting device, was realized with a standard 10×25 monocular, a Tasco model 568 BCRD. This inexpensive commercially-available monocular was found to have an easily-removed eyepiece tube. The method for removing it, and mounting a planned transparent image inside the eyepiece tube, is as follows. Remove the soft plastic cover on the eyepiece end of the monocular, using a razor blade as needed to cut it and peel it away from the underlying hard plastic tube. Then unscrew the outer plastic retaining ring at the very end of the eyepiece. This will release the eyepiece, along with the focusing adjustment ring, allowing access to the interior end of the eyepiece tube. Use several o-rings of outer diameter ½″, with the transparent image sandwiched between them, to hold that transparent image securely at the ocular lens focal plane within the eyepiece barrel. If the individual who will serve as the laser projector is myopic or hyperopic, then the position of the transparent image should be optimized so that it is easily focused through the eyepiece onto the retina of that particular individual. Then the eyepiece, the focusing adjustment ring, and the retaining ring should be replaced in their original position.

What is claimed is:

1) The method of projecting a planned graphical image upon a specific pre-selected remote target surface with multiple laser beams, separately controlled by multiple persons known as laser projectors, with each laser beam contributing only one spot of light to the graphical image; comprising the following steps.
a. Creating a planned image, consisting of a photograph, drawing, or other scale representation of a landscape that includes easily identifiable invariant visual features of the said remote target surface, as viewed from the position of a typical member of the group of said laser projectors; along with the said planned graphical image superimposed upon the said representation of said invariant visual features.
b. Making multiple transparent image copies of said planned image, of an appropriate size or sizes to approximately match the apparent size of the actual said target surface when the latter is viewed from the expected location(s) of the laser projectors, through sighting optics having designated ranges of magnification; each said transparent image copy containing a designating mark or marks specifying a particular spot-like picture element (spot-pixel) within the desired graphical image; and the multiple transparent image copies having sufficient numbers of different spot-pixel designations so as to permit the overall graphical image to be created from the aligned composition of all the designated spot-pixels.
c. Distributing one of the said transparent image copies to each member of the said group of laser projectors who, at the chosen time of projection of the said planned image, are to be positioned in a cluster of locations limited only by the requirement of having viewing angles of the said target surface that differ from that of the said planned image by no more than 30 degrees of horizontal or vertical parallax angle.
d. Directing the said laser projectors to align said sighting optics so that each laser projector's view of his/her said transparent image copy will be visually superimposed upon his/her view of the said target surface, thereby bringing each said laser projector's laser beam into accurate alignment with his/her individually-designated spot-pixel upon the said remote target surface, each said laser having previously been affixed to the corresponding sighting optic so as to align the output laser optical axis with the sighting optical axis of said sighting optic.

2) The method of claim 1, where the said remote target surface is part of a fountain, monument, bridge, ceiling, domed roof, slanted roof, interior wall, or exterior wall constructed by humans.

3) The method of claim 1, where the said remote target surface is a waterfall or the side of a mountain, hill, cliff, bluff, or butte found within a natural landscape.

4) The method of claim 1, where the said remote target surface is the Moon.

5) The method of claim 1, where the said remote target surface is more than 1 kilometer from any of the lasers projecting upon it.

6) The method of claim 1, where the lasers are battery-powered diode laser pointers or battery-powered diode-pumped solid state laser pointers.

7) The method of claim 1, where the said planned graphical image includes a secondary color of yellow or orange that is produced by combining intensities from both green and red lasers shining onto the same spot-pixel or spot-pixels.
